(19) United States
(12) Patent Application Publication
(10) Pub. No.: US 2014/0063035 A1
(43) Pub. Date: Mar. 6, 2014

(54) Image Display Apparatus and Method for Displaying Image on Display Device

(71) Applicant: Yamaha Corporation, Hamamatsu-shi (JP)

(72) Inventors: Yoshiyasu HIRAI, Iwata-shi (JP); Yukinari NISHIKAWA, Hamamatsu-shi (JP); Mitsuhiro HONME, Hamamatsu-shi (JP)

(73) Assignee: Yamaha Corporation, Hamamatsu-shi (JP)

(21) Appl. No.: 14/014,705

(22) Filed: Aug. 30, 2013

(30) Foreign Application Priority Data
Sep. 4, 2012 (JP) 2012-194328

(51) Int. Cl. G09G 3/36

(52) U.S. Cl. CPC G09G 3/3611
USPC 345/559; 345/98

(57) ABSTRACT

An image display apparatus is coupled to a nonvolatile memory section, and includes an image processing part configured to display an image on a display device, an initial setting circuit, and a control register configured to control respective parts in the image display apparatus. At power-on or start-up of the image display apparatus, the initial setting circuit reads initialization data from the nonvolatile memory section and sets communication mode for communicating with the nonvolatile memory section to the control register. The communication mode is specified by the initialization data. After the initial setting circuit sets the communication mode to the control register, the image processing part reads image data from the nonvolatile memory section by using the communication mode set in the control register and displays an initial image relating to the image data on the display device.

### BACKGROUND

1. Technical Field

The present disclosure relates to an image display apparatus that displays an image on a display device such as an LCD (Liquid Crystal Display) and a method for displaying the image on the display device.

2. Background Art

FIG. 15 is a block diagram illustrating a structure of an image display system using an image display LSI (Large-Scale Integration) 1 as an example of a conventional image display apparatus. In this image display system, the image display LSI 1 executes image processing for displaying various kinds of images on an LCD (Liquid Crystal Display) 2 according to instructions from a microcomputer 10. An image memory 3 which is a nonvolatile memory such as a flash ROM stores various pieces of image data to be displayed on the LCD 2. A nonvolatile memory 20 is connected to the microcomputer 10. The nonvolatile memory 20 stores initialization firmware for initializing the entire image display system including the image display LSI 1. The microcomputer 10 reads the initialization firmware from the nonvolatile memory 20 and executes the initialization firmware at the timing of power-on or system start-up. Thereby, the image display LSI 1 is initialized. Thereafter, according to an instruction from the microcomputer 10, the image display LSI 1 reads image data from the image memory 3 and displays the image data on the LCD 2. The image display LSI 1 used for this type of image display system is disclosed, for example, in JP-A-2001-83958.

The conventional art has the following problems. First, in some image display systems, the time required for the microcomputer 10 to execute the initialization firmware is long. The image display systems of this type have a problem that the time from power-on or system start-up to the start of screen display on the LCD 2 is long and this makes the user anxious or unsatisfied. In addition, the initialization processing of the image display LSI 1 is complicated in procedure and timing. This complicated initialization processing is a cause that makes the initialization firmware difficult to create and increases the development period of the initialization firmware.

### SUMMARY

The present disclosure is made in view of such circumstances, and a first object thereof is to provide an image display apparatus and a method for displaying an image capable of reducing the required time from power-on or the like to the completion of initialization of the image display apparatus. A second object of the present disclosure is to reduce the effort required for the development of a routine for the initialization of the image display apparatus in the development of the firmware of the microcomputer that controls the image display apparatus.

In order to achieve the above object, according to the present disclosure, there is provided an image display apparatus coupled to a nonvolatile memory section, comprising:

an image processing part configured to display an image on a display device;

an initial setting circuit; and

a control register configured to control respective parts in the image display apparatus,

wherein at power-on or start-up of the image display apparatus, the initial setting circuit reads initialization data from the nonvolatile memory section and sets communication mode for communicating with the nonvolatile memory section to the control register, the communication mode being specified by the initialization data;

wherein after the initial setting circuit sets the communication mode to the control register, the image processing part reads image data from the nonvolatile memory section by using the communication mode set in the control register and displays an initial image relating to the image data on the display device.

For example, the nonvolatile memory section has an image memory which stores the image data and a nonvolatile memory which stores the initialization data, at the power-on or the start-up of the image display apparatus, the initial setting circuit reads the initialization data from the nonvolatile memory and sets the communication mode for communicating with the image memory to the control register, the communication mode being specified by the initialization data, and the image processing part reads the image data from the image memory by using the communication mode set in the control register and displays an initial image relating to the image data on the display device.

For example, the nonvolatile memory section is configured by a single image memory which stores the image data and the initialization data.

For example, the image display apparatus further comprises: a clock generating part configured to perform frequency multiplication on an input clock to generate a system clock of the image display apparatus, the initial setting circuit sets a multiplication rate of the frequency multiplication to the control register, and the multiplication rate of the frequency multiplication is specified by the initialization data which is read from the nonvolatile memory section.

For example, the initial setting circuit reads a test value prestored in the image memory by a plurality of kinds of communication modes, compares the test value with an expected value, and reads the initialization data from the image memory by using the communication mode where the read test value coincides with the expected value.

For example, the image display apparatus further comprises: a multiplication rate setting terminal to which a value is set, and a multiplication rate of the frequency multiplication to the input clock is set to the control register on the basis of the value set to the multiplication rate setting terminal before the initialization data is read from the nonvolatile memory section.

For example, the image display apparatus further comprises: a byte count setting terminal to which a value is set, and the image processing part reads the image data from the nonvolatile memory section by using a reading mode before the initialization data is read from the nonvolatile memory section, the reading mode being set to the control register on the basis of the value set to the byte count setting terminal.

For example, a Large-Scale Integration device having the image display apparatus.

According to the present disclosure, there is also provided a method for displaying an image on a display device, the method comprising:

at power-on or start-up of an image display apparatus, reading initialization data from a nonvolatile memory section and setting communication mode for communicating with the nonvolatile memory section to a control register, the communication mode being specified by the initialization data;

after setting the communication mode to the control register, reading image data from the nonvolatile memory section by using the communication mode set in the control register; and

displaying an initial image relating to the image data on the display device.

For example, the nonvolatile memory section has an image memory which stores the image data and a nonvolatile memory which stores the initialization data, at the power-on or the start-up of the image display apparatus, the initialization data is read from the nonvolatile memory and the communication mode for communicating with the image memory is set to the control register, and the image data is read from the image memory by using the communication mode set in the control register.

For example, the nonvolatile memory section is configured by a single image memory which stores the image data and the initialization data.

For example, the method further comprises:

setting a multiplication rate of a frequency multiplication to the control register, the multiplication rate of the frequency multiplication being specified by the initialization data which is read from the nonvolatile memory section; and

performing frequency multiplication on an input clock with the multiplication rate to generate a system clock of the image display apparatus.

For example, the method further comprises:

reading a test value prestored in the image memory by a plurality of kinds of communication modes;

comparing the test value with an expected value; and

reading the initialization data from the image memory by using the communication mode where the read test value coincides with the expected value.

For example, the image display apparatus is provided with a multiplication rate setting terminal to which a value is set, and the method further comprises: setting a multiplication rate of the frequency multiplication to the input clock to the control register on the basis of the value set to the multiplication rate setting terminal before the initialization data is read from the nonvolatile memory section.

For example, the image display apparatus is provided with a byte count setting terminal to which a value is set, and the method further comprises:

setting a reading mode to the control register on the basis of the value set to the byte count setting terminal; and

reading the image data from the nonvolatile memory section by using the reading mode before the initialization data is read from the nonvolatile memory section.

According to the above configuration and processing, since the initial setting circuit of the image display apparatus reads the initialization data from the nonvolatile memory section at power-on or start-up of the image display apparatus and performs the initial setting of the control register, the initial setting can be completed in a short time. Moreover, according to the present disclosure, since the information necessary for the initial setting of the image display apparatus is stored in the nonvolatile memory section as the initialization data, even when the specifications of the nonvolatile memory section and the display device to be controlled by the image display apparatus are changed, the firmware of the microcomputer that controls the image display apparatus is never changed.

### BRIEF DESCRIPTION OF THE DRAWINGS

The above objects and advantages of the present disclosure will become more apparent by describing in detail preferred exemplary embodiments thereof with reference to the accompanying drawings, wherein:

FIG. 1 is a block diagram illustrating a structure of an image display system including an image display LSI according to a first embodiment of the present disclosure;

FIG. 2 is a flowchart illustrating an operation of a stand-alone initial setting function in the embodiment;

FIG. 3 is a view explaining an initial setting of a multiplication rate of a PLL in the embodiment;

FIG. 4 is a circuit diagram illustrating an example of a system clock generation method in the embodiment;

FIG. 5 is a circuit diagram illustrating a method of generating a system clock by performing a frequency multiplication by the PLL in the embodiment;

FIG. 6 is a time chart illustrating an operation of access to an SPI flash ROM in 3-byte address mode;

FIG. 7 is a time chart illustrating an operation of access to the SPI flash ROM in 4-byte address mode;

FIG. 8 is a circuit diagram illustrating an internal state of the image display LSI at the time of the initial setting;

FIG. 9 is a circuit diagram illustrating another internal state of the image processing LSI at the time of the initial setting;

FIG. 10 is a view explaining a procedure for selecting an appropriate communication mode of the image memory in a second embodiment of the present disclosure;

FIG. 11 is a view explaining the procedure for selecting the appropriate communication mode of the image memory in the second embodiment;

FIG. 12 is a view explaining the procedure for determining whether a switching of the communication mode of the image memory is performed normally or not in a third embodiment of the present disclosure;

FIG. 13 is a view explaining the procedure for determining whether the switching of the communication mode of the image memory was performed normally or not in the embodiment;

FIG. 14 is a view explaining the procedure for determining whether the switching of the communication mode of the image memory is performed normally or not in a fourth embodiment of the present disclosure; and

FIG. 15 is a block diagram illustrating an example of a structure of the conventional image display system using the image display LSI.

### DETAILED DESCRIPTION OF EXEMPLARY EMBODIMENTS

Hereinafter, referring to the drawings, embodiments of the present disclosure will be described.

### First Embodiment

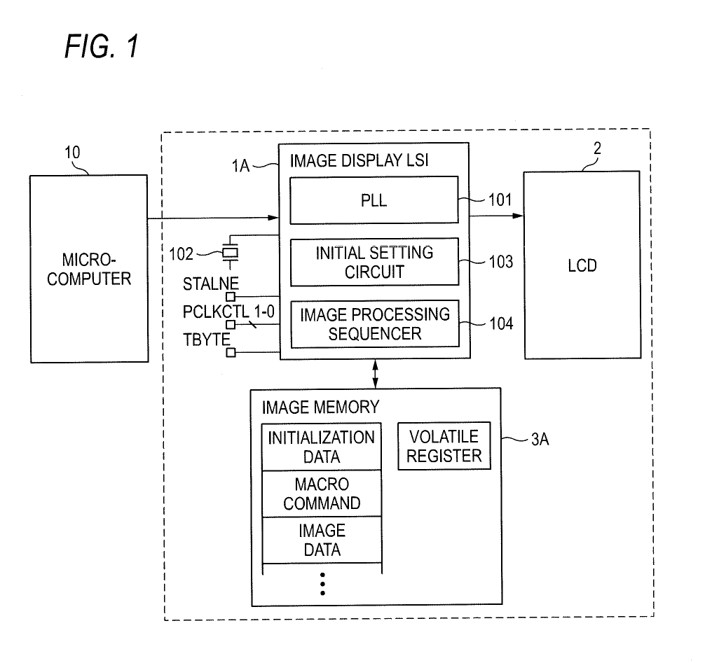

FIG. 1 is a block diagram illustrating the structure of an image display system including an image display LSI 1A according to a first embodiment of the present disclosure. In this example, a control board (not shown) is provided on the rear surface of a panel type LCD 2, and the image display LSI 1A and an image memory 3A (nonvolatile memory section) are mounted on the control board. A microcomputer 10 is mounted on a board different from the control board.

The image display LSI 1A has a PLL (phase locked loop) 101, an initial setting circuit 103 and an image processing sequencer 104. Moreover, a crystal oscillator 102 is externally attached to the image display LSI 1A. The PLL 101 is a circuit that performs frequency multiplication on the input clock obtained from the crystal oscillator 102 and generates a system clock for performing the timing control of each element in the image display LSI 1A. The initial setting circuit 103 initializes the condition of each element in the image display LSI 1A at power-on or start-up of the image display LSI 1A. Here, the term “at start-up” indicates, for example, the timing when an initialization signal is supplied to an initialization terminal (not shown) provided in the image display LSI 1A. The image processing sequencer 104 is a circuit that reads image data from the image memory 3A according to a macro command stored in the image memory 3A or a macro command supplied from the microcomputer 10, and displays an image relating to the image data on the LCD 2.

The image memory 3A stores initialization data, the macro command and the image data. The initialization data is used for the initialization of the image display LSI 1A, and includes control data used for the control to cause the LCD 2 to perform a display operation such as the number of pixels of the LCD 2 in the vertical direction and the number of pixels thereof in the horizontal direction, the multiplication rate of the PLL 101, information related to the generation condition of an interrupt signal to the microcomputer 10 and information to specify the communication mode of the image memory 3A. The image data is data displayed as an image on the LCD 2.

The image memory 3A in the first embodiment is formed of an SPI (serial peripheral interface) flash ROM, and has a two-way high-speed communication mode using two wires or four wires in addition to a normal serial communication mode. The image memory 3A has a volatile register. The image memory 3A starts to operate in the normal serial communication mode by the initialization performed at power-on or the like. Moreover, the image memory 3A switches the communication mode according to a command supplied from the image display LSI 1A. When the switching of the communication mode is done, a status indicating whether the switching of the communication mode ended in success or failure is written into the volatile register. The image display LSI 1A is capable of performing polling to read the status in the volatile register.

The present embodiment is characterized by a stand-alone initialization function of the image display LSI 1A initializing various control registers based on the initialization data stored in the image memory 3A at power-on or start-up. The initial setting circuit 103 in the image display LSI 1A performs this stand-alone initialization function. The image processing sequencer 104 in the image display LSI 1A generates various control signals for performing display control of the LCD 2 based on the storage contents of the control registers initialized by the workings of the stand-alone initialization function. The control registers are provided in the image display LSI 1A.

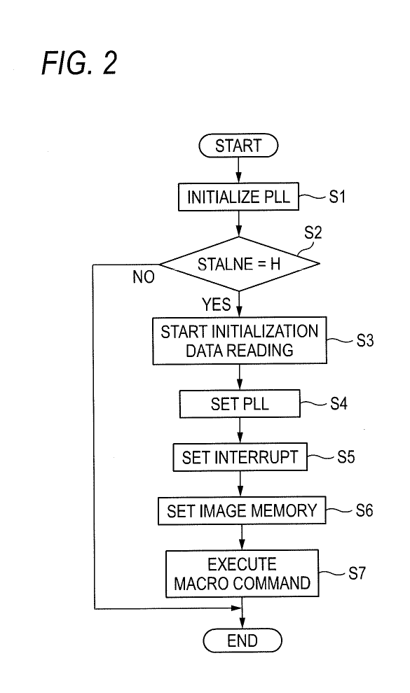

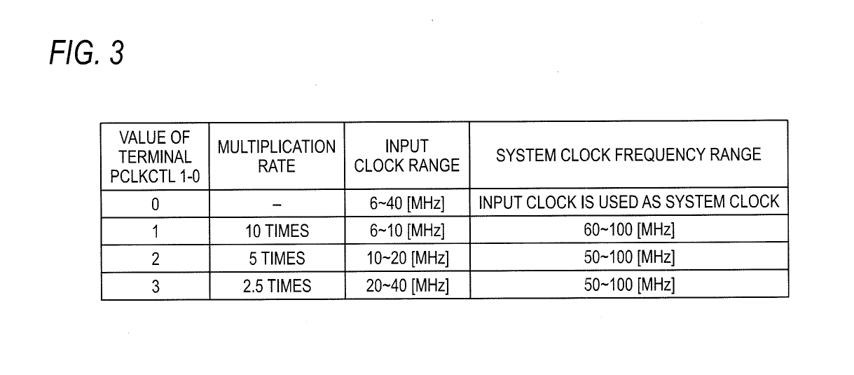

FIG. 2 is a flowchart illustrating the operation of the stand-alone initialization function in the present embodiment. In response to power-on or start-up, the initial setting circuit 103 of the image display LSI 1A executes PLL initialization processing (step S1). Hereinafter, referring to FIG. 3 to FIG. 5, the PLL initialization processing (step S1) will be described.

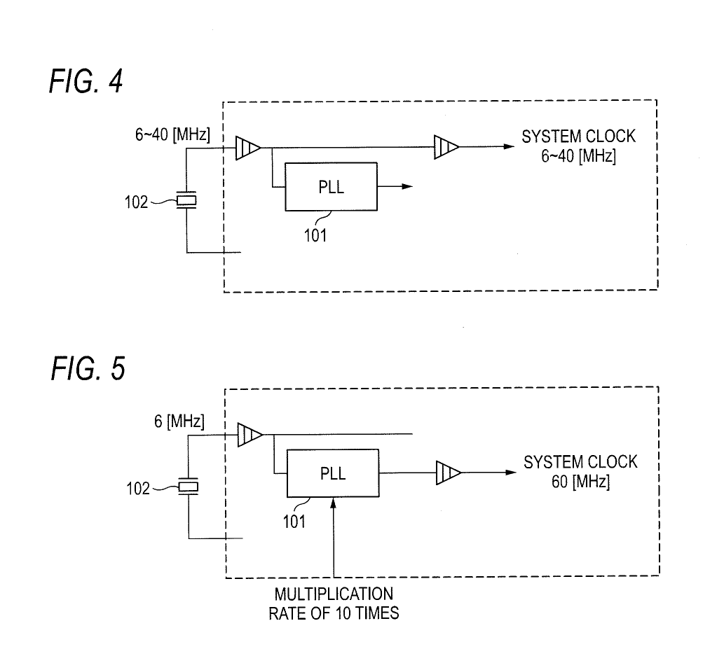

In the present embodiment, the multiplication rate to be set for the PLL 101 is stored in the image memory 3A as part of the initialization data. However, this multiplication rate has not been read from the image memory 3A at the stage of the power-on or start-up of the image display LSI 1A. Therefore, it is considered to use the input clock supplied from the crystal oscillator 102 as the system clock as shown in FIG. 4. For example, when it is assumed that the frequency of the system clock is 96 [MHz] and the frequency of the input clock obtained from the crystal oscillator 102 is six [MHz], the multiplication rate to be set for the PLL 101 is 16 times. However, when the input clock is used as the system clock without performing the frequency multiplication on the input clock, the frequency of the system clock is 1/16 of 96 [MHz] which is the intrinsically required frequency, so that the time required for initializing the image display LSI 1A is 16 times compared with when a multiplication rate of 16 times is set. Accordingly, in the present embodiment, in order to set an appropriate multiplication rate for the PLL 101 under the condition where the multiplication rate is not read from the image memory 3A, the image display LSI 1A is provided with a two-bit multiplication rate setting terminal PCLKCTL 1-0. The level (value) supplied to the multiplication rate setting terminal PCLKCTL 1-0 is set based on the frequency of the input clock supplied from the crystal oscillator 102 to the image display LSI 1A.

Then, at step S1, as shown in FIG. 3, the image display LSI 1A sets the multiplication rate for the PLL 101 according to the condition (set value) of the multiplication rate setting terminal PCLKCTL 1-0. In the example shown in FIG. 3, assuming that the frequency of the input clock can range from six to 40 [MHz], the multiplication rate set for the PLL 101 is determined with the goal of obtaining a system clock of a frequency of not less than 50 MHz from this input clock. As shown in FIG. 3, when the value of the two bits supplied to the multiplication rate setting terminal PCLKCTL 1-0 is “0”, there is no frequency multiplication (that is, the input clock is used as the system clock), and when the value is “1”, “2” and “3”, multiplication rates of ten times, five times and 2.5 times are selected, respectively.

In the example shown in FIG. 5, in a case where the frequency of the input clock from the crystal oscillator 102 is six [MHz], since the two bits set for the multiplication rate setting terminal PCLKCTL 1-0 indicates “1”, a multiplication rate of ten times is set for the PLL 101, and a system clock of 60 MHz is outputted from the PLL 101.

The contents of the two bits set for the multiplication rate setting terminal PCLKCTL 1-0 are determined at the time of design of the control board mounted with the image display LSI 1A. That is, the control board mounted with the image display LSI 1A is designed so that in FIG. 3, a multiplication rate where the frequency of the system clock outputted from the PLL 101 is in the vicinity of the upper limit of the allowable range is selected and that the two bits specifying the multiplication rate are supplied to the multiplication rate setting terminal PCLKCTL 1-0.

The above is the details of the PLL initialization processing of step S1 in FIG. 2.

Then, the initial setting circuit 103 of the image display LSI 1A determines whether the level of an STALNE terminal provided on the image display LSI 1A is H level or not (step S2). When the result of this determination is “NO”, the process ends. In this case, the image display LSI 1A waits for the initialization by the microcomputer 10. On the other hand, when the level of the STALNE terminal is H level (step S2=“YES”), steps S3 to S7 are executed.

First, at step S3, the initial setting circuit 103 of the image display LSI 1A starts reading of the initialization data from the image memory 3A. At this time, the initial setting circuit 103 determines the level of a byte count setting terminal TBYTE provided on the image display LSI 1A. The reason therefor is as follows:

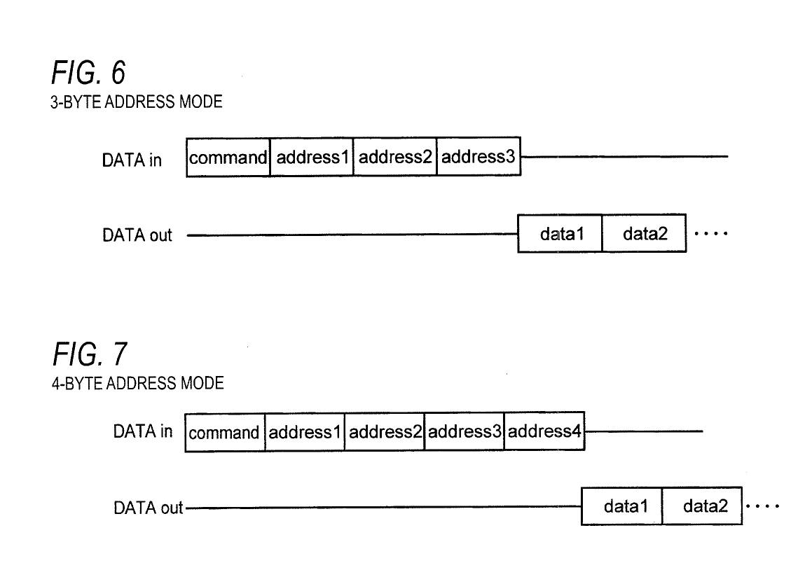

In the present embodiment, the method of access to the SPI flash ROM used as the image memory 3A is necessarily changed according to the storage capacity thereof. Describing further in detail, when the image memory 3A is an SPI flash ROM having a storage capacity smaller than 128 Mbits, it is necessary for the initial setting circuit 103 to perform data reading in 3-byte address mode as shown in FIG. 6. That is, following a one-byte command, three bytes of addresses address1 to address3 specifying access destinations are supplied to the SPI flash ROM as serial data DATAin, and pieces of data data1, data2, . . . read from the access destinations are received as serial data DATAout. On the other hand, when the image memory 3A is an SPI flash ROM having a storage capacity of not less than 128 Mbits, it is necessary for the initial setting circuit 103 to perform data reading in 4-byte address mode as shown in FIG. 7. That is, following a one-byte command, four bytes of addresses address1 to address4 specifying the access destinations are supplied to the SPI flash ROM as the serial data DATAin, and data data1, data2, . . . read from the access destinations are received as the serial data DATAout.

As described above, in the present embodiment, since the SPI flash ROM is used as the image memory 3A, it is necessary to select an appropriate reading mode from between 3-byte address mode and 4-byte address mode when access to the image memory 3A is made. Accordingly, in the present embodiment, the image display LSI 1A is provided with the byte count setting terminal TBYTE, and by the level setting of the byte count setting terminal TBYTE, an appropriate reading mode between 3-byte address mode and 4-byte address mode is pointed out to the image display LSI 1A.

At step S3 shown in FIG. 2, the initial setting circuit 103 selects one of 3-byte address mode and 4-byte address mode based on the level of the byte count setting terminal TBYTE, and starts reading of the initialization data from the image memory 3A in the selected reading mode.

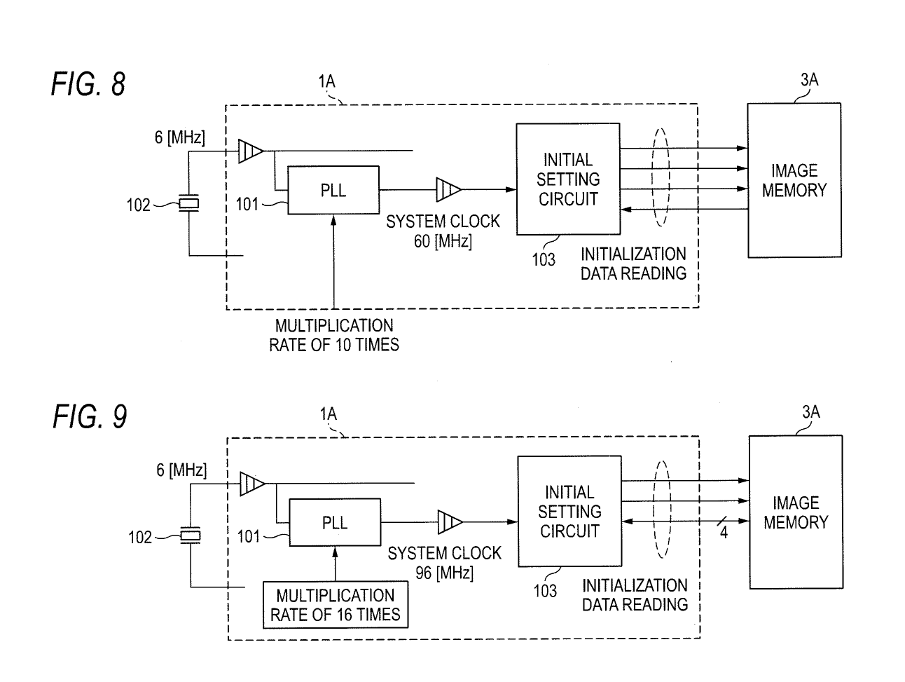

FIG. 8 shows the internal state of the image display LSI 1A when step S3 is executed. In this example, the PLL 101 performs, on the input clock, a frequency multiplication at a multiplication rate of ten times set at step S1, and the initial setting circuit 103 in the image display LSI 1A is supplied with a system clock of 60 [MHz] obtained from the PLL 101. In synchronism with this system clock, the initial setting circuit 103 reads the initialization data from a predetermined storage area of the image memory 3A. In doing this, the initial setting circuit 103 reads the initialization data from the image memory 3A in the normal serial communication mode. This is because in the present embodiment, the image memory 3A operates in the normal serial communication mode in the initial state such as at power-on.

In FIG. 2, steps S4 to S6 are processing that the initial setting circuit 103 executes while reading the initialization data from the image memory 3A. The initialization data read from the image memory 3A includes the multiplication rate of the PLL 101, information indicating the generation condition of the interrupt signal to the microcomputer 10 and information specifying the communication mode of the image memory 3A. When the multiplication rate is read as the initialization data, the initial setting circuit 103 sets this multiplication rate to a control register for setting the frequency division ratio of a frequency divider in the PLL 101 (step S4). Then, when the information indicating the generation condition of the interrupt signal to the microcomputer 10 is read as the initialization data, the initial setting circuit 103 sets this information to a control register used for the interrupt signal generation control (step S5).

Then, when the information specifying the communication mode of the image memory 3A is read as the initialization data, the initial setting circuit 103 switches the communication mode of the image memory 3A according to this readout data. Describing further in detail, the initial setting circuit 103 suspends the reading of the initialization data, sets the communication mode specified by the initialization data to a control register for communication control in the image display LSI 1A, and supplies the image memory 3A with a command to provide an instruction to make switching to the communication mode. Thereby, in the image memory 3A, the communication mode specified by the command from the initial setting circuit 103 is set. Moreover, in the image memory 3A, a status indicating whether the switching of the communication mode ended in success or failure is written into the internal volatile register. After the provision of the instruction to switch the communication mode, the initial setting circuit 103 repeats polling to read the status from the volatile register of the image memory 3A, and when the status indicating normal end is read, the initial setting circuit 103 resumes the suspended initialization data reading.

FIG. 9 illustrates the internal state of the image display LSI 1A after the execution of the step S6 (setting of the image memory). In the example shown in FIG. 9, a multiplication rate of 16 times is set for the PLL 101 based on the initialization data read from the image memory 3A (step S4), and a system clock of 96 MHz is generated by the PLL 101. As the mode for communication with the image memory 3A, a two-way high-speed transmission mode using four wires is set (step S6).

After reading all the pieces of the initialization data from the image memory 3A and finishing storing them in the control registers of the image display LSI 1A, the initial setting circuit 103 instructs the image processing sequencer 104 to perform the macro command execution shown in FIG. 2 (step S7). Thereby, the image processing sequencer 104 reads and executes a series of macro commands stored subsequently to the initialization data in the image memory 3A. This series of macro commands is macro commands for displaying an initial screen by animation on the LCD 2, and includes information specifying the image data used for the animation display. The image processing sequencer 104 reads the image data specified by the macro command from the image memory 3A, and supplies it to the LCD 2 to display the animation.

Thereby, the initialization of the image display LSI 1A by the stand-alone initialization function is completed. Thereafter, the control of the image display LSI 1A by the microcomputer 10 is started, and the image display LSI 1A performs display control of the LCD 2 according to a command from the microcomputer 10.

Then, the operation of the image display LSI 1A is stopped, and thereafter, when power-on or start-up is performed, the image display LSI 1A reads the initialization data from the image memory 3A in the normal serial communication mode at step S3 of FIG. 2.

The above is the details of the present embodiment.

According to the present embodiment, the following effects are obtained:

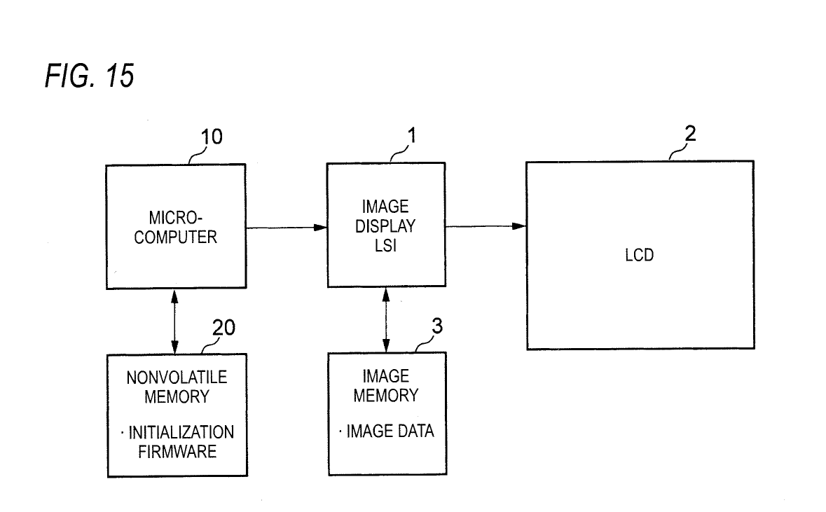

(1) According to the above-described conventional art, the microcomputer 10 performs the initialization of the image display LSI 1 according to the initialization firmware (see FIG. 15). This initialization firmware is an aggregate of a multiplicity of instructions. Under the conventional art, the microcomputer 10 interprets and executes the instructions constituting the initialization firmware to thereby carry out the initialization of the image display LSI 1. For this reason, the time required for the initialization of the image display LSI 1 to be completed is long.

On the contrary, in the present embodiment, such initialization of the image display LSI 1A by the initialization firmware is not performed. The image display LSI 1A in the present embodiment has the initial setting circuit 103 that, when power-on or the like is performed, reads the initialization data from a predetermined storage area of the image memory 3A in synchronism with the system clock and stores the initialization data in an internal control register. By the workings of the initial setting circuit 103, all the pieces of initialization data necessary for the initialization are stored in the control registers in the image display LSI 1A. Therefore, according to the present embodiment, the initialization of the image display LSI 1A can be completed in a shorter time than according to the conventional art.

(2) Before conducting the initial setting to the control register, an appropriate multiplication rate is set for the PLL 101 by the setting of the multiplication rate setting terminal of the image display LSI 1A, and the initialization data specifying the multiplication rate is read from the image memory 3A, whereby the multiplication rate specified by the initialization data is set for the PLL 101. Consequently, the initialization data can be read from the image memory 3A at high speed in synchronism with the system clock generated by the PLL 101, and set to the control register.

(3) There are cases where the specifications of the image memory 3A used for the image display system are changed. However, in the present embodiment, the initialization data related to the specifications of the image memory 3A is stored in the image memory 3A, and the image display LSI 1A performs initial setting related to the specifications of the image memory 3A according to this initialization data in the image memory 3A. Therefore, according to the present embodiment, it is unnecessary to change the contents of the firmware executed by the microcomputer 10 even if the specifications of the image memory 3A are changed.

(4) The number of addressing bytes of the SPI flash ROM used as the image memory 3A differs according to the manufacturer and the product number. However, according to the present embodiment, since the information related to the number of addressing bytes can be specified by the terminal setting of the image display LSI 1A, the image display LSI 1A can select an appropriate number of bytes and access the SPI flash ROM without any control from the microcomputer 10.

(5) By the initial setting using the initialization data in the image memory 3A, the communication mode of the image memory 3A can be switched from the normal serial communication mode to the two-way high-speed communication mode using four wires. Consequently, the initial setting can be performed at high speed.

(6) In the present embodiment, the image memory 3A stores initialization data, the macro command and the image data. However, the initialization data and the macro command may be stored in a non volatile memory (non volatile memory section) different from the image data 3A (non volatile memory section), and the image data may be stored in the image memory 3A.

### Second Embodiment

In the first embodiment, the communication mode in the initial state of the image memory 3A is fixed to the normal serial communication mode. On the contrary, in the second embodiment, the communication mode in the initial state of the image memory 3A is not fixed. In the present embodiment, when the initial setting circuit 103 reads the initialization data from the image memory 3A at step S3 of FIG. 2, the communication mode of the image memory 3A is unknown. Therefore, in the present embodiment, the initial setting circuit 103, an appropriate communication mode is selected as follows.

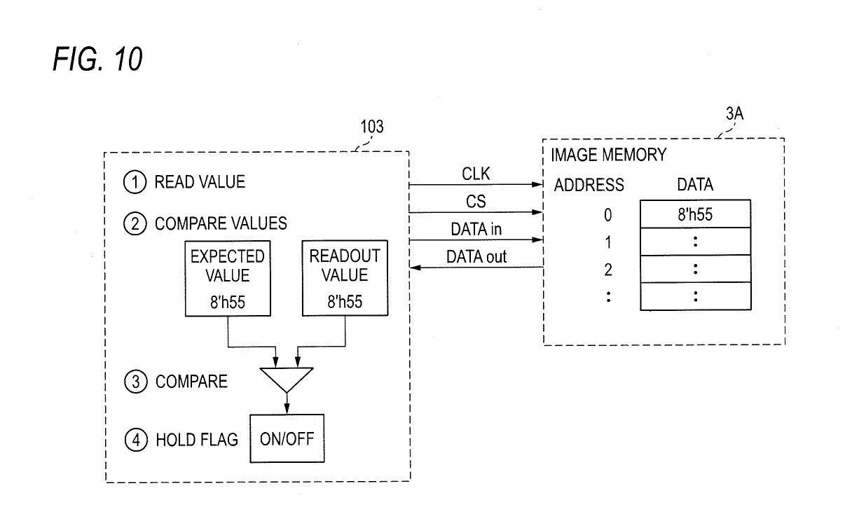

For example, as shown in FIG. 10, a known test value 8′h55 (This means eight-bit data that can be expressed as 55 in hexadecimal. Ditto for the following) is stored, for example, at address 0 of the image memory 3A. This test value is data read from the image memory 3A in order to determine whether reading from the image memory 3A is normally performed or not. Normally, when a reading error occurs at the image memory 3A, the readout data is 8′h00 or 8′hFF. For this reason, data other than 8′h00 or 8′hFF is used as the test value.

Then, at step S3 of FIG. 3, the initial setting circuit 103 first reads the data at address 0 of the image memory 3A by the normal serial communication mode as shown in FIG. 10. Further describing in detail, a chip select signal CS for the image memory 3A is set to active level and synchronized with a clock CCK, and serial data DATAin representative of the readout command and the address 0 is supplied to the image memory 3A. Then, the initial setting circuit 103 receives serial data DATAout from the image memory 3A, and obtains the readout data from the serial data DATAout. Then, the initial setting circuit 103 compares the readout data with an expected value 8′h55 prestored in an internal ROM. When these coincide with each other, the initial setting circuit 103 sets a first flag to ON, and when these do not coincide with each other, the initial setting circuit 103 sets the first flag to OFF.

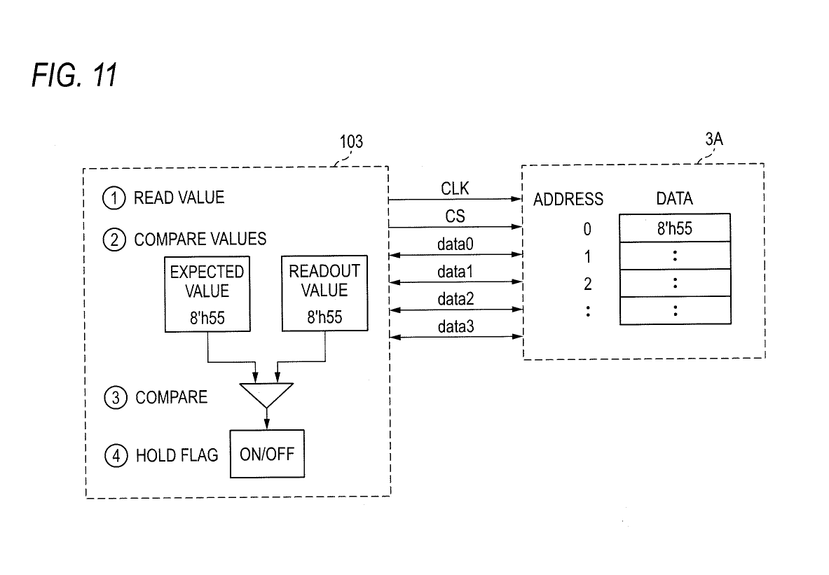

Then, as shown in FIG. 11, the initial setting circuit 103 reads data from address 0 of the image memory 3A by the two-way high-speed communication mode using four wires. Then, the initial setting circuit 103 compares the readout data with the expected value 8′h55 prestored in the internal ROM. When these coincide with each other, the initial setting circuit 103 sets a second flag to ON, and when these do not coincide with each other, the initial setting circuit 103 sets the second flag to OFF.

Then, based on the ON/OFF of the first and second flags, the initial setting circuit 103 selects the mode of communication with the image memory 3A. That is, when the first flag is ON, the initial setting circuit 103 selects the normal serial communication mode as the mode of communication with the image memory 3A, and when the second flag is ON, the initial setting circuit 103 selects the four-wire high-speed communication mode.

In the above operation, in a case where the data at address 0 is read from the image memory 3A by the normal serial communication mode and the readout data coincides with the expected value, the initial setting circuit 103 may start the operation of reading the initialization data from the image memory 3A by the normal serial communication mode without performing reading of the expected value by the four-wire high-speed communication mode.

According to the present embodiment, even when the communication mode of the image memory 3A is unknown, it is possible to determine the communication mode of the image memory 3A and access the image memory 3A from the image display LSI 1A in an appropriate communication mode. The present embodiment is advantageous in that it is unnecessary to fix the communication mode of the image memory 3A in the initial state.

### Third Embodiment

In the setting of the image memory (step S6 of FIG. 2) in the first embodiment, when the initial setting circuit 103 instructs the image memory 3A to make switching from the normal serial communication mode to the two-way high-speed communication mode using four wires, the mode switching sometimes ends in failure. When this happens, the initial setting circuit 103 cannot read the correct initialization data from the image memory 3A. To avoid such inconvenience, the initial setting circuit 103 in the present embodiment performs the following before and after the switching of the communication mode of the image memory 3A:

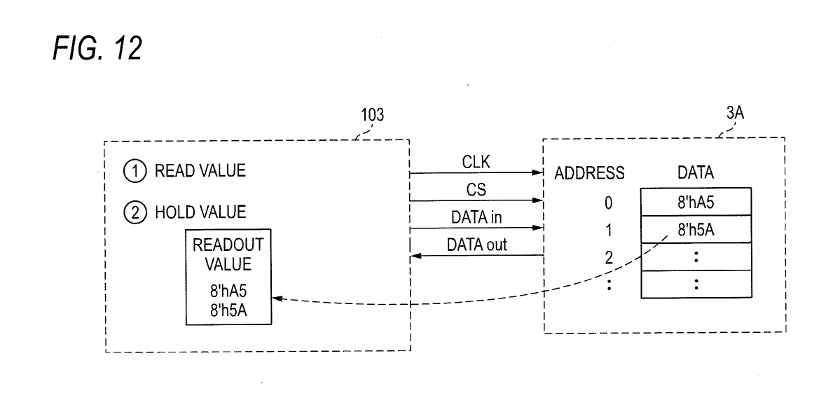

First, before switching the communication mode, as shown in FIG. 12, the initial setting circuit 103 reads test values 8′hA5 and 8′h5A prestored at predetermined addresses (in this example, addresses 0 and 1) of the image memory 3A by the serial communication mode, and holds them in an internal register.

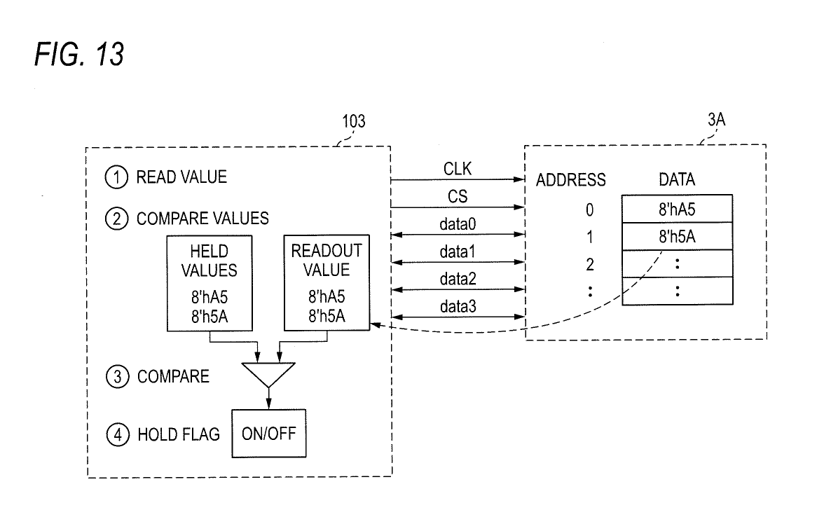

Then, after providing an instruction to make switching from the serial communication mode to the four-wire high-speed communication mode, as shown in FIG. 13, the initial setting circuit 103 reads the test values 8′hA5 and 8′h5A from the same addresses (in this example, addresses 0 and 1) of the image memory 3A, and compares them with the data held in the internal register. When these coincide with each other, the initial setting circuit 103 sets the flag to ON, and when these do not coincide with each other, the initial setting circuit 103 sets the flag to OFF.

Then, when the flag is ON, the initial setting circuit 103 estimates that the switching from the serial communication mode to the four-wire high-speed communication mode completed normally, and starts reading of the initialization data from the image memory 3A.

On the other hand, when the flag is OFF, the initial setting circuit 103 estimates that the switching from the serial communication mode to the four-wire high-speed communication mode is unsuccessful, and again instructs the image memory 3A to make switching from the serial communication mode to the four-wire high-speed communication mode. Then, the initial setting circuit 103 again reads the test values 8′hA5 and 8′h5A from the same addresses of the image memory 3A, and repeats a similar determination.

According to the present embodiment, when the switching of the communication mode of the image memory 3A ended in failure, it is possible to detect that and execute the communication mode switching again. Consequently, the reliability of the access to the image memory 3A by the image display LSI 1A can be enhanced.

### Fourth Embodiment

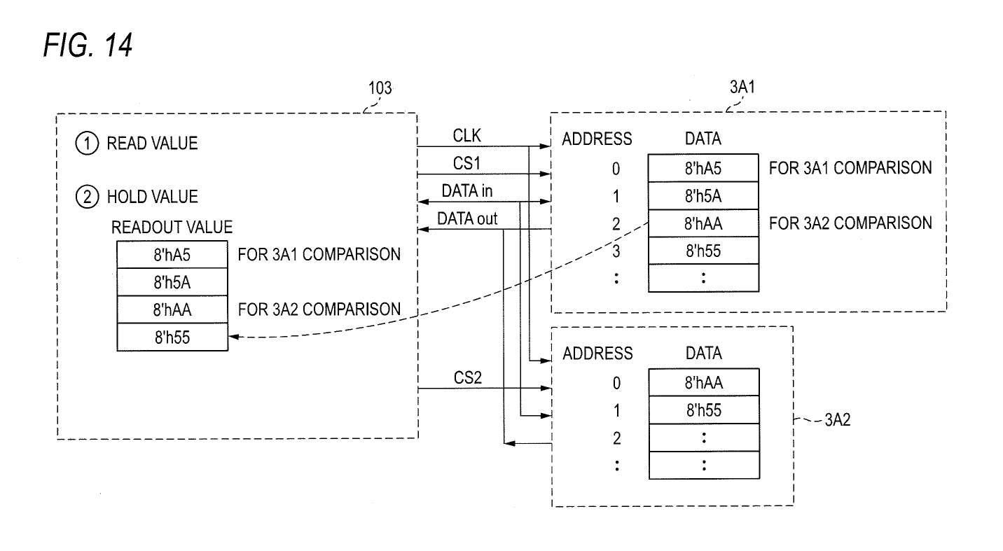

As shown in FIG. 14, an image display system according to the fourth embodiment is provided with two image memories 3A1 and 3A2 (nonvolatile memory section). The present disclosure is a system in which the third embodiment is applied to an image display system provided with a plurality of the image memories 3A1 and 3A2.

In the present embodiment, the test values 8′hA5 and 8′h5A read in order to determine whether the data reading from the image memory 3A1 is normally performed or not are stored at addresses 0 and 1 of the image memory 3A1. Moreover, test values 8′hAA and 8′h55 read in order to determine whether the data reading from the image memory 3A2 is performed normally or not are stored at addresses 0 and 1 of the image memory 3A2. Further, the test values 8′hAA and 8′h55 the same as those stored at the addresses 0 and 1 of the image memory 3A2 are stored at addresses 2 and 3 of the image memory 3A1.

In the present embodiment, the initial setting circuit 103 performs the following before and after the switching of the communication mode of the image memories 3A1 and 3A2 from the serial communication mode to the two-wire two-way high-speed communication mode:

First, before switching the communication mode, the initial setting circuit 103 sets a chip select signal CS1 for the image memory 3A1 to active level, reads the test values 8′hA5 and 8′h5A for the image memory 3A1 and the test values 8′hAA and 8′h55 for the image memory 3A2 from addresses 0, 1, 2 and 3 of the image memory 3A1 by the serial communication mode, and holds them in an internal register.

Then, the initial setting circuit 103 provides the image memories 3A1 and 3A2 with an instruction to make switching from the serial communication mode to the two-wire high-speed communication mode.

Then, the initial setting circuit 103 sets the chip select signal CS1 for the image memory 3A1 to active level, reads the test values 8′hA5 and 8′h5A for the image memory 3A1 from addresses 0 and 1 of the image memory 3A1 by the two-wire high-speed communication mode, and compares them with the test values 8′hA5 and 8′h5A for the image memory 3A1 stored in the internal register. As a result of this comparison, when these coincide with each other, the initial setting circuit 103 sets the first flag to ON, and when these do not coincide with each other, the initial setting circuit 103 sets the first flag to OFF.

Then, the initial setting circuit 103 sets a chip select signal CS2 for the image memory 3A2 to active level, reads the test values 8′hAA and 8′h55 for the image memory 3A2 from addresses 0 and 1 of the image memory 3A2 by the two-wire high-speed communication mode, and compares them with the test values 8′hAA and 8′h55 for the image memory 3A2 stored in the internal register. As a result of this comparison, when these coincide with each other, the initial setting circuit 103 sets the second flag to ON, and when these do not coincide with each other, the initial setting circuit 103 sets the second flag to OFF.

Then, the initial setting circuit 103 determines the first and second flags. When the first and second flags are both ON, the initial setting circuit 103 deems that the switching from the serial communication mode to the two-wire high-speed communication mode completed normally, and starts reading of the initialization data from the image memory 3A.

On the other hand, when either the first or the second flag is OFF, the initial setting circuit 103 deems that the switching from the serial communication mode to the two-wire high-speed communication mode was unsuccessful, makes the mode switching again, and repeats a similar determination.

While a case where two image memories 3A1 and 3A2 are used has been described above as an example, the same applies to a case where three or more image memories 3A are used.

According to the present embodiment, even when a plurality of image memories 3A are provided, the switching of the communication modes thereof can be performed collectively, so that an effect is obtained that the control of the communication mode switching is facilitated.

### Other Embodiments

While the first to fourth embodiments of the present disclosure have been described above, other embodiments are considered for the present disclosure, for example, as follows:

(1) In the first embodiment, in switching the communication mode of the image memory 3A, the initial setting circuit 103 repeats polling to the image memory 3A until the status indicating that the switching ended normally is read from the volatile register of the image memory 3A. However, when a status indicating a failure is always read by the polling, the initialization data reading processing is fixed (stopped). Therefore, to avoid this problem, a structure may be adopted in which the initial setting circuit 103 is provided with a timer and when a timeout occurs after the start of the polling, an instruction to switch the communication mode is again sent from the initial setting circuit 103 to the image memory 3A.

(2) In the first embodiment, the image display LSI 1A is provided with the byte count setting terminal TBYTE. However, instead of providing the byte count setting terminal TBYTE, the following may be performed. A known test value is stored at a predetermined address of the image memory 3A, at step S3 of FIG. 2, the initial setting circuit 103 performs reading of the test value in is 3-byte address mode and reading of the test value in 4-byte address mode, selects the mode in which the known test value could be read normally, and starts reading of the initialization data. According to this mode, since it is unnecessary to provide the image display LSI 1A with the byte count setting terminal TBYTE, the number of terminals of the image display LSI 1A can be reduced.

(3) A structure may be adopted in which the image display LSI 1A is provided with a flag indicating whether the operation by the stand-alone initial setting function has ended or not and a flag indicating whether there is no error and the microcomputer 10 is capable of reading these flags. In this case, when starting the control of the image display LSI 1A, with reference to these flags, the microcomputer 10 can take appropriate measures such that when an error occurs, the control of the image display LSI 1A is started after processing to recover the erroneous part is performed. Alternatively, it may be performed that when the operation by the stand-alone initial setting function failure, an interrupt signal providing notification of the failure is outputted from the image display LSI 1A to the microcomputer 10.

(4) A forced termination register writable from the microcomputer 10 may be provided on the image display LSI 1A. When a command to order a forced termination is written from the microcomputer 10 into the forced termination register while the initial setting circuit 103 is executing the processing by the stand-alone initial setting function (see FIG. 2), the initial setting circuit 103 stops the processing. According to this mode, the operation of the image display LSI 1A can be stopped by the forced termination command from the side of the microcomputer 10 in order to prevent the stand-alone initial setting function from going out of control.

(5) In the above-described embodiments, normally, the microcomputer 10 starts the control of the image display LSI 1A while the image processing sequencer 104 of the image display LSI 1A is displaying the initial screen on the LCD 2 according to a macro command in the image memory 3A. In that case, it is preferable that the microcomputer 10 having started the control of the image display LSI 1A is capable of continuously displaying the initial screen on the LCD 2. Therefore, the address of the macro command executed by the image processing sequencer 104 to display the initial screen may be stored in a register. When the microcomputer 10 starts the control of the image display LSI 1A, the image processing sequencer 104 is instructed to execute the macro command specified by the address in the register. By doing this, the display of the initial screen can be continued.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2012-194328 filed on Sep. 4, 2012, the contents of which are incorporated herein by reference.

What is claimed is:

1. An image display apparatus coupled to a nonvolatile memory section, comprising:
an image processing part configured to display an image on a display device;
an initial setting circuit; and
a control register configured to control respective parts in the image display apparatus,
wherein at power-on or start-up of the image display apparatus, the initial setting circuit reads initialization data from the nonvolatile memory section and sets communication mode for communicating with the nonvolatile memory section to the control register, the communication mode being specified by the initialization data;
wherein after the initial setting circuit sets the communication mode to the control register, the image processing part reads image data from the nonvolatile memory section by using the communication mode set in the control register and displays an initial image relating to the image data on the display device.

2. The image display apparatus according to claim 1, wherein the nonvolatile memory section has an image memory which stores the image data and a nonvolatile memory which stores the initialization data;
wherein at the power-on or the start-up of the image display apparatus, the initial setting circuit reads the initialization data from the nonvolatile memory and sets the communication mode for communicating with the image memory to the control register, the communication mode being specified by the initialization data; and
wherein the image processing part reads the image data from the image memory by using the communication mode set in the control register and displays an initial image relating to the image data on the display device.

3. The image display apparatus according to claim 1, wherein the nonvolatile memory section is configured by a single image memory which stores the image data and the initialization data.

4. The image display apparatus according to claim 1, further comprising:
a clock generating part configured to perform frequency multiplication on an input clock to generate a system clock of the image display apparatus,
wherein the initial setting circuit sets a multiplication rate of the frequency multiplication to the control register; and
wherein the multiplication rate of the frequency multiplication is specified by the initialization data which is read from the nonvolatile memory section.

5. The image display apparatus according to claim 1, wherein the initial setting circuit reads a test value prestored in the nonvolatile memory section by a plurality of kinds of communication modes, compares the test value with an expected value, and reads the initialization data from the nonvolatile memory section by using the communication mode where the read test value coincides with the expected value.

6. The image display apparatus according to claim 4, further comprising:
a multiplication rate setting terminal to which a value is set,
wherein a multiplication rate of the frequency multiplication to the input clock is set to the control register on the basis of the value set to the multiplication rate setting terminal before the initialization data is read from the nonvolatile memory section.

7. The image display apparatus according to claim 1, further comprising:
a byte count setting terminal to which a value is set,
wherein the image processing part reads the image data from the nonvolatile memory section by using a reading mode before the initialization data is read from the nonvolatile memory section, the reading mode being set to the control register on the basis of the value set to the byte count setting terminal.

8. A Large-Scale Integration device having the image display apparatus according to claim 1.

9. A method for displaying an image on a display device, the method comprising:
at power-on or start-up of an image display apparatus, reading initialization data from a nonvolatile memory section and setting communication mode for communicating with the nonvolatile memory section to a control register, the communication mode being specified by the initialization data;
after setting the communication mode to the control register, reading image data from the nonvolatile memory section by using the communication mode set in the control register; and
displaying an initial image relating to the image data on the display device.

10. The method according to claim 9, wherein the nonvolatile memory section has an image memory which stores the image data and a nonvolatile memory which stores the initialization data;
wherein at the power-on or the start-up of the image display apparatus, the initialization data is read from the nonvolatile memory and the communication mode for communicating with the image memory is set to the control register; and
wherein the image data is read from the image memory by using the communication mode set in the control register.

11. The method according to claim 9, wherein the nonvolatile memory section is configured by a single image memory which stores the image data and the initialization data.

12. The method according to claim 9, further comprising:
setting a multiplication rate of a frequency multiplication to the control register, the multiplication rate of the frequency multiplication being specified by the initialization data which is read from the nonvolatile memory section; and
performing frequency multiplication on an input clock with the multiplication rate to generate a system clock of the image display apparatus.

13. The method according to claim 9, further comprising:
reading a test value prestored in the nonvolatile memory section by a plurality of kinds of communication modes;
comparing the test value with an expected value; and
reading the initialization data from the nonvolatile memory section by using the communication mode where the read test value coincides with the expected value.

14. The method according to claim 12, wherein the image display apparatus is provided with a multiplication rate setting terminal to which a value is set,
the method further comprising:
setting a multiplication rate of the frequency multiplication to the input clock to the control register on the basis of the value set to the multiplication rate setting terminal before the initialization data is read from the nonvolatile memory section.

15. The method according to claim 9, wherein the image display apparatus is provided with a byte count setting terminal to which a value is set,
the method further comprising:
setting a reading mode to the control register on the basis of the value set to the byte count setting terminal; and
reading the image data from the nonvolatile memory section by using the reading mode before the initialization data is read from the nonvolatile memory section.
